(19) United States
(12) Patent Application Publication
(10) Pub. No.: US 2025/0388125 A1
(43) Pub. Date: Dec. 25, 2025

(54) METHOD FOR CONTROLLING A BATTERY FOR AN ELECTRIC VEHICLE, A CONTROLLER, AND AN ELECTRIC VEHICLE

(71) Applicants: HYUNDAI MOTOR COMPANY, Seoul (KR); KIA CORPORATION, Seoul (KR)

(72) Inventor: Won Jae Lee, Hwaseong-si (KR)

(73) Assignees: HYUNDAI MOTOR COMPANY, Seoul (KR); KIA CORPORATION, Seoul (KR)

(21) Appl. No.: 18/962,372

(22) Filed: Nov. 27, 2024

(30) Foreign Application Priority Data
Jun. 20, 2024 (KR) 10-2024-0080334

(51) Int. Cl. B60L 58/21

(52) U.S. Cl. CPC B60L 58/21; B60L 2240/421; B60L 2240/423

(57) ABSTRACT

A method for controlling an electric vehicle battery is provided. The electric vehicle includes a plurality of wheels, a driving motor for supplying driving power to the plurality of wheels, and a controller for controlling power supply to the driving motor and/or charging by the driving motor. The method includes selecting, by the controller, a battery among a first battery and a second battery according to an operation point of the driving motor. The method also includes controlling, by the controller, the power supply and/or the charging by using the selected battery.

### CROSS-REFERENCE TO RELATED APPLICATION

The present application claims the benefit of and priority to Korean Patent Application No. 10-2024-0080334, filed on Jun. 20, 2024, the entire contents of which are hereby incorporated herein by reference.

### TECHNICAL FIELD

The present disclosure relates to a method for controlling a battery for an electric vehicle, an electric vehicle controller, and an electric vehicle.

### BACKGROUND

In general, an electric vehicle, a type of mobility device, is operated with wheels driven by the driving force of a driving motor.

Typically, a high-voltage battery is fixedly mounted in a vehicle to supply power to a driving motor.

The driving motor may be an AC motor and an inverter may be included between a battery and a driving motor.

According to a charging status, e.g., a State of Charge (SOC), when charging is required, a battery of an electric vehicle may be charged by receiving external power through an onboard charger (OBC).

A charging time may be determined according to charging methods, including slow charging and fast charging.

With the continuous research and development on batteries, the driving distance per one charging has recently greatly improved.

However, the battery fixedly mounted in the battery of an electric vehicle may not be sufficient.

### SUMMARY

The present disclosure was made to alleviate or solve the above-described conventional problems.

Embodiments of the present disclosure provide an effective operation strategy of a dual battery based on an operation point of a driving motor.

Embodiments of the present disclosure provide a new concept of technology that uses a second high-voltage battery added to or detached from the power system of an electric vehicle when necessary in addition to a first high-voltage battery preset in the electric vehicle.

According to an embodiment of the present disclosure, a method for controlling a battery of a vehicle is provided. The vehicle includes a plurality of wheels, a driving motor for supplying a driving force to the plurality of wheels, and a controller configured to control power supply to the driving motor or charging by the driving motor. The method includes determining, by the controller, one battery between a first battery and a second battery according to an operation point of the driving motor. The method also includes controlling, by the controller, the power supply or the charging using the determined battery.

Determining the one battery may include determining the one battery according to revolutions per minute (RPM), a torque, and a power of the driving motor.

Determining the one battery according to the RPM, the torque, and the power of the driving motor may include determining a control mode between a torque control mode and a power control mode according to the RPM.

Determining the control mode may include determining the torque control mode when the RPM is smaller than a reference RPM, and determining the power control mode when the RPM is equal to or greater than the reference RPM.

The torque control mode may include, when the torque is greater than a predetermined discharging torque, determining a higher voltage battery between the first battery and the second battery, when the torque is smaller than the predetermined discharging torque, determining a lower voltage battery between the first battery and the second battery, when the torque is smaller than a predetermined charging torque, determining the higher voltage between the first battery and the second battery, and when the torque is greater than the predetermined charging torque, determining the lower voltage between the first battery and the second battery.

The power control mode may include when the power is greater than a predetermined discharging power, determining a higher voltage battery between the first battery and the second battery, when the power is smaller than the predetermined discharging power, determining a lower voltage battery between the first battery and the second battery, when the power is smaller than a predetermined charging power, determining the higher voltage battery between the first battery and the second battery, and when the power is greater than the predetermined charging power, determining the lower voltage battery between the first battery and the second battery.

Controlling the one or both of power supply or the charging using the determined battery may include additionally using another battery based on a determination that the determined one battery fails to satisfy the power.

Determining the one battery according to the RPM, the torque, and the power of the driving motor may include determining an operation section to which the operation point belongs among a plurality of operation sections, the plurality of operation sections being set based on a torque-RPM map of the driving motor.

The plurality of operation sections may be set based on at least one of a constant power reference line, a constant APS reference line, and an RPM reference line.

The constant power reference line may be set based on an efficiency of a lower voltage battery between the first battery and the second battery.

The plurality of operation sections may include at least two or more of, a first operation section below the RPM reference line and the constant APS reference line, a second operation section surrounded by the constant power reference line, the constant APS reference line, and a set maximum torque line, a third operation section beyond the constant power reference line, and a fourth operation section beyond the RPM reference line and below the constant power reference line.

Determining the one battery may include at least one of, in response the operation point being within the second operation section, determining a higher voltage battery between the first battery and the second battery as the one battery, and in response to the operation point being within the fourth operation section, determining a lower voltage between the first high-voltage battery and the second high-voltage battery as the one battery.

Determining the one battery may include at least one of, in response to the operation point within the first operation section, determining the lower voltage battery between the first battery and the second as the one battery, and in response to the operation point within the third operation section, determining the higher voltage battery between the first battery and the second battery as the one battery.

The method may further include the controller determining a driving mode as a high-torque mode.

The high-torque mode may include at least one of a Sports Mode or a Track Mode.

Determining of the one battery may further include the controller determining that the second battery is detachably connected to a power system including the first battery.

According to another embodiment of the present disclosure, a controller is provided. The controller includes a memory storing instructions and one or more processors configured to execute the instructions. The instructions, when executed by the one or more processors, cause the controller to determine one battery between a first battery and a second battery according to an operation point of the driving motor, and control power supply to a driving motor in a vehicle or charging by the driving motor using the determined battery.

According to yet another embodiment of the present disclosure, a vehicle is provided. The vehicle includes a plurality of wheels, a driving motor configured to supply a driving force to the plurality of wheels, and a controller including a memory storing instructions and one or more processors configured to execute the instructions to control power supply to the driving motor or charging by the driving motor. The instructions, when executed by the one or more processors, cause the controller to determine one battery between a first battery and a second battery according to an operation point of the driving motor, and control the power supply or the charging using the determined battery.

Determining the one battery may include determining the one battery according to an RPM, a torque, and a power of the driving motor.

Determining the one battery according to the RPM, the torque, and the power of the driving motor may include determining a control mode between a torque control mode and a power control mode according to the RPM.

According to an embodiment, energy efficiency may be ensured through an efficient usage strategy of a dual battery according to an operation point of a driving motor.

Power loss may be reduced and system efficiency may be increased by separating usage areas of two batteries according to voltages by minimizing the current consumption.

According to an embodiment of the present disclosure, the driving distance of an electric vehicle may be increased and the usability may be improved by detachably connecting a second high-voltage battery to a power system of an electric vehicle.

### BRIEF DESCRIPTION OF DRAWINGS

FIG. 1 is a view illustrating a power system of a first mobility device, according to an embodiment of the present disclosure;

FIG. 2 is a view illustrating that a first mobility device is connected to a second mobility device, according to an embodiment of the present disclosure;

FIG. 3 is a view illustrating a control process, according to an embodiment of the present disclosure;

FIG. 4 is a view illustrating specifications of a first high-voltage battery and a second high-voltage battery, according to an embodiment of the present disclosure;

FIG. 5 is a view illustrating division of a plurality of operation sections in a torque-RPM map, according to an embodiment of the present disclosure;

FIG. 6 is a view illustrating use of a first battery in a current-RPM map, according to an embodiment of the present disclosure;

FIG. 7 is a view illustrating use of a first battery and/or a second battery in a current-RPM map, according to an embodiment of the present disclosure;

FIG. 8 is a view illustrating use of a first battery and/or a second battery in a torque-RPM map, according to an embodiment of the present disclosure; and

FIG. 9 is a view illustrating a control simulation, according to an embodiment of the present disclosure.

### DETAILED DESCRIPTION

While embodiments of the present disclosure are described in detail below with reference to the accompanying drawings, it should be understood that various changes and modifications may be made without departing from the scope and sprit of the present disclosure. Further, it should be understood that the present disclosure is not limited to the specific embodiments thereof, and various changes, equivalences, and substitutions may be made without departing from the scope and spirit of the present disclosure.

In the present disclosure, terms such as “module”, “unit”, “part”, and the like are terms used for nominal distinct between components, and it should not be interpreted as assuming that the components are physically and chemically separate or capable of being separated or divided.

Terms containing ordinal numbers, such as “first”, “second”, etc., may be used to describe various components, but the components are not limited by the terms. These terms may be used only in a nominal sense to differentiate one component from another component, and their mutual sequential meaning should be understood through the context of the corresponding description, not through such terms.

The term “and/or” is used to include all instances of any combination of multiple items being the subject. For example, “A and/or B” includes all three cases: “A”, “B”, and “A and B”.

When a component is described as being “coupled” or “connected” to another component, it should be understood that the component may be either connected directly to another component, or connected indirectly via another medium.

When a component, device, element, or the like of the present disclosure is described as having a purpose or performing an operation, function, or the like, the component, device, or element should be considered herein as being “configured to” meet that purpose or perform that operation or function.

The terms in the present disclosure are used to describe example embodiments and do not intend to restrict and/or limit the present disclosure. Singular forms are intended to include plural forms unless the context clearly indicates otherwise. In the present disclosure, terms such as “include,” “comprise,” or “consist of” are used to designate presence of characteristics, numbers, steps, operations, elements, components or a combination thereof, and do not exclude the presence or possibility of addition of one or more other characteristics, numbers, steps, operations, elements, components or a combination thereof.

Unless otherwise defined, all terms used in the present disclosure including technical or scientific terms, have the same meaning as generally understood by a person of ordinary skill in the art to which the present disclosure pertains. Terms defined in commonly used dictionaries should be interpreted as having a meaning consistent with the meaning in the context of the related technology, and unless clearly defined in the present disclosure, should not be interpreted in an ideal or excessively formal sense.

In addition, the terms “unit”, “control unit”, “control device”, or “controller” are used for names of devices that control the corresponding functions, and are not construed as being generic functional units. For example, devices using the terms may include a communication device that communicates with another controller or sensor to control the corresponding function, a computer-readable recording media that stores operating systems, logic commands, input/output information, etc., and at least one or more of processor that performs determination, calculation, decision, etc. used to control the corresponding function.

A processor may include a semiconductor integrated circuit and/or electronic elements that perform at least one or more of comparison, determination, calculation, and decision to achieve a programmed function. For example, the processor may be one or the combination of a computer, a microprocessor, a CPU, an ASIC, and electronic circuits (circuitry, logic circuits).

A computer-readable recording medium (or referred to as memory) includes all types of storage devices that store data that is read by a computer system. Examples of the computer-readable recording medium may include at least one a memory of flash memory type, hard disk type, micro type, and card type (e.g. Secure Digital Card (SD Card) or eXtream Digital Card (XD Card)), and a memory of Random Access Memory (RAM), Static RAM (SRAM), Read-Only Memory (ROM), Programmable ROM (PROM), Electrically Erasable PROM (EEPROM), and magnetic RAM (MRAM), a magnetic disk, and an optical disk type.

Such recording medium may be electrically connected to the processor, and the processor may load and record data from the recording medium. The recording medium and processor may be integrated or may be physically separated.

Embodiments of the present disclosure are described below with reference to the accompanying drawings.

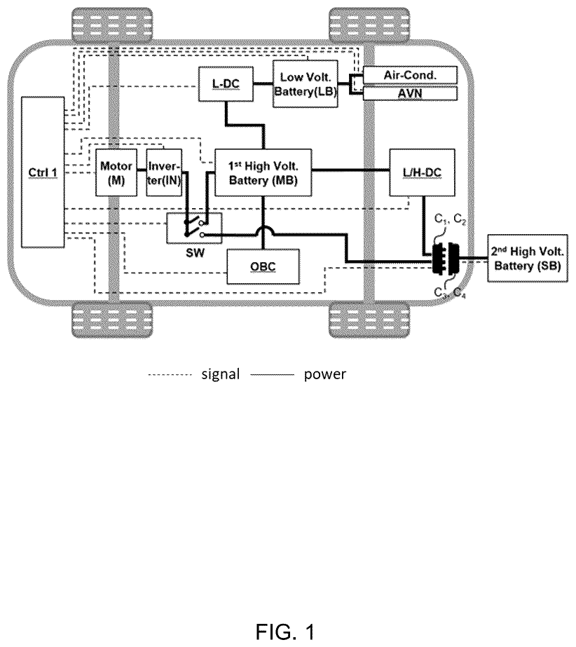

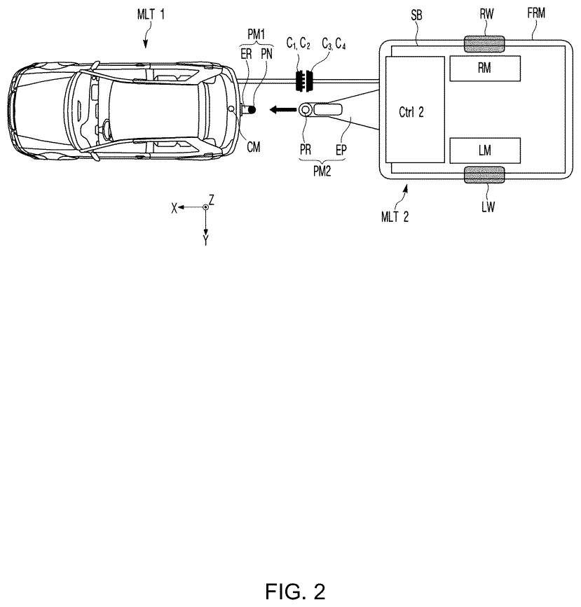

FIG. 1 is a schematic view illustrating a power system of a first mobility device MLT 1 (e.g., an electric vehicle). FIG. 2 is a view illustrating that a second mobility device MLT 2 is connected to the first mobility device MLT 1.

Referring to FIG. 1 and FIG. 2, the respective structures of the first mobility device MLT 1 and the second mobility device MLT 2, according an embodiment, are described.

Referring to FIG. 1, the first mobility device MLT 1 according to an embodiment may be, for example, an electric vehicle, including a first driving motor M, an inverter IN, a first high-voltage battery MB, an on-board charger OBC, a first DC/DC converter L-DC, a low-voltage battery LB, an air conditioning equipment Air-cond. that operates at a low-voltage, an Audio Video Navigation AVN, a second DC/DC converter L/H-DC, a switch SW, and a controller (referred to as a first controller).

The first driving motor M may provide a driving force to the wheels of the vehicle. The first driving motor M may be an alternating current motor.

The inverter IN may invert a direct current power supplied to the first driving motor M to an alternating current.

The first high-voltage battery MB may be fixedly provided in the body of the first mobility device MLT 1, for example, under the bottom of a vehicle cabin.

The first high-voltage battery MB may mainly supply electric power to the first driving motor M, and may be charged with the onboard charger OBC.

The first high-voltage battery MB may be connected to the low-voltage battery LB through the first DC/DC converter L-DC to charge the low-voltage battery LB.

The first DC/DC converter L-DC may be a step-down DC/DC converter (LDC; low-voltage DC-DC converter) to charge the low-voltage battery LB.

The low-voltage battery LB may be, for example, a battery of 12V or 24V, and may supply electric power to electric devices in the vehicle such as the air conditioning equipment, the AVN, etc. that operate at a low voltage.

The second high-voltage battery SB in FIG. 1 may be provided in the second mobility device MLT 2, and may be mechanically connected through a connection mechanism described below. However, the present disclosure is not limited thereto. For example, the second high-voltage battery SB may be detachably placed in the first mobility device to be mechanically connected.

The second high-voltage battery SB may be electrically connected in a wired manner (or wirelessly in a range possible) to the vehicle power system including the first high-voltage battery MB as an additional in a way that the second high-voltage battery SB may not affect the operation of the power system (power supply to vehicle electronics, a driving motor, etc.)

The second high-voltage battery SB may be a replaceable battery, an auxiliary battery, an extended battery, or a secondary battery, but this is only for distinction from the first high-voltage battery MB. In other words, the second high-voltage battery SB may not be limited by the name with functions, characteristics, relationships with other objects (the first high-voltage battery MB, a host vehicle, etc.), or its own mechanical/electrical/chemical structure, battery type (types of packaging method, anode material/cathode material/separator material, etc.), charging method, etc.

The second high-voltage battery SB may be connected in a wired manner or wirelessly with the first controller Ctrl 1 of the first mobility device MLT 1, or a battery management system (BMS) of the first high-voltage battery MB. Various sensing information (e.g., voltage, current, temperature, etc.) related to the SOC state, physical/electrical/chemical status of the second high-voltage battery SB may be transmitted to the first controller Ctrl 1. However, the present disclosure is not limited thereto. In an example, the information on the second high-voltage battery SB may be transmitted to the first controller Ctrl 1 through a second controller Ctrl 2 of the second mobility device MLT 2.

According to an embodiment, a high-voltage battery applied to the first high-voltage battery MB and the second high-voltage battery SB may include, for example, a plurality of battery cells (not shown) that output a voltage of 2.7 to 4.2 V. The plurality of battery cells may be connected in series/parallel to each other in a preset number to form a single module, for example. The high-voltage battery may be packaged in one battery package with one or more battery modules connected in series/parallel to output a desired output voltage, for example, approximately 400 V, 800 V, or several kV.

The first high-voltage battery MB and the second high-voltage battery SB each may include the battery management system (BMS).

The BMS may include a battery management unit (BMU), a cell monitoring unit (CMU), and/or a battery junction box (BJB).

The BMS may perform a cell balancing function to ensure the performance of the entire battery pack by constantly maintaining the voltage of each cell, a State of Charge (SoC) function to calculate the capacity of the entire battery system, battery cooling, charging, discharging control, etc.

The BMU may receive information on all cells from the CMU and perform the functions of the BMS based on the information.

The BMU may include or consist of, for example, two (2) micro-control units MCU. Each MCU may include a single controller network area (CAN) communication port. The MCU may include a CAN interface to communicate with a vehicle controller which is the upper-level device of the BMS, and a CAN interface for collecting the information of the CMU which is the lower-level device.

The CMU may be directly attached to a battery cell to perform sensing of voltage, current, temperature, etc. The CMU may not perform calculations related to BMS algorithms but may perform sensing. A plurality of battery cells may be connected to a single CMU, and information on each cell may be transmitted to the BMU through the CAN interface.

The BJB may be a pack-level detection mechanism of the BMS and a connection medium between a high-voltage battery and a drivetrain. The BJB may measure and record a battery voltage and a current flowing inside and outside the battery to accurately calculate the SoC. The BJB may perform important functions for safety such as overcurrent detection, insulating monitoring, etc.

The second high-voltage battery SB may be a high-voltage battery lower than the first high-voltage battery MB. Accordingly, the second DC/DC converter L/H-DC may be a step-up DC/DC converter. The second high-voltage battery SB may be a high-voltage battery higher than the first high-voltage battery MB. Accordingly, the second DC/DC converter L/H-DC may be a step-down DC/DC converter. According to an embodiment, the second DC/DC converter L/H-DC may be bidirectional. Therefore, the first high-voltage battery MB and the second high-voltage battery SB may charge and discharge each other.

According to an embodiment, the second DC/DC converter L/H-DC may be built in the first mobility device MLT 1 in the power system. However, the present disclosure is not limited thereto. For example, unlike an embodiment of the present disclosure, the second DC/DC converter L/H-DC may be provided as a separate component and may be additionally and detachably connected to the power system. The second DC/DC converter L/H-DC may be built in or detachably placed in the second mobility device MLT 2.

According to another embodiment, the second DC/DC converter L/H-DC may not be included. In this case, the charging and discharging between the first high-voltage battery MB and the second high-voltage battery SB may not occur.

For the detachable electrical connection of the second high-voltage battery SB to the power system, the power system of the first mobility device MLT 1 may include first and second connectors C1 and C2, and the second high-voltage battery SB may include third and fourth connectors C3 and C4.

For example, the first and second connectors C1 and C2 may be connectors in an integrated form, and the third and fourth connectors C3 and C4 may also be connectors in an integrated form.

The first connector C1 may be connected to the second DC/DC converter L/H-DC, and the second connector C2 may be connected to the switch SW.

Although not shown, a signal transmission connector may be added to transmit sensing and status information on the second high-voltage battery SB to the controller.

The switch SW may be fixedly and electrically connected to the inverter IN. The switch SW may be switched between the first high-voltage battery MB and the second connector C2 to connect the first high-voltage battery MB to the inverter IN or electrically connect the inverter IN to the second high-voltage battery SB.

The first controller Ctrl 1 may be a vehicle controller of the highest level to control all electrical devices in the first mobility device MLT 1. However, the present disclosure is not limited thereto. For example, the first controller Ctrl 1 in FIG. 1 may be a power controller of the lower level from the vehicle controller.

According to an embodiment, the first controller Ctrl 1 may include a computer-readable recording medium that stores an operating system, logic commands, input/output information, etc., and one or more processors that read the information to perform judgments, calculations, decisions, etc.

The second high-voltage battery SB in FIG. 1 may be provided in the second mobility device MLT 2 as shown in FIG. 2.

The second mobility device MLT 2 may include a frame FRM, a second left-wheel LW placed on the left of the frame FRM, a second right-wheel RW placed on the right of the frame FRM, a second left-driving motor LM for providing a driving force to the second left-wheel LW, a second right-driving motor RM for providing a driving force to the second right-wheel RW, and a second controller Ctrl 2.

The second high-voltage battery SB may be fixedly provided in the second mobility device MLT 2. However, the present disclosure is not limited thereto. The second high-voltage battery SB may be detachably placed in the second mobility device MLT 2. The second high-voltage battery SB mounted in the frame FRM with a fully-discharged SoC status may be removed, and replaced with a new second high-voltage battery SB with a full-charged SoC status.

When the second high-voltage battery SB is fixedly mounted in the second mobility device MLT 2, the second mobility device MLT 2 may include a charging connector for charging the second high-voltage battery SB.

The frame FRM may form the exterior of the second mobility device MLT 2 and accommodate other components.

The frame FRM may include a second pivot mechanism PM2 as a second connection mechanism. The second pivot mechanism PM2 may be detachably pivot-connected to a first pivot mechanism PM1 which is a first connection mechanism fixed to the body of the first mobility device MLT1.

The first pivot mechanism PM1 may include an extension rod ER extending from the body of the first mobility device MLT 1 rearwardly, and a pivot pin PN upwardly protruding from the end of the extension rod ER.

The second pivot mechanism PM2 may include an extension unit EP in a triangle shape, straightforwardly protruding from the frame FRM of the second mobility device MLT 2, and a pivot ring PR into which the pivot pin PN is rotatably inserted from the end of the extension unit EP.

The pivot pin PN may be limited in linear movement while being inserted into the pivot ring PR, but may rotate with respect to a Z-axis direction in FIG. 2. Therefore, while being pivot-connected, the second mobility device MLT 2 may be limited in linear movement with regard to the first mobility device MLT 1 based on the pivot connection point, but may rotate with respect to the z-axis.

When driving in the forward direction, i.e. in the X-axis direction, the first mobility device MLT 1 and the second mobility device MLT 2 may maintain straight driving without separate steering control for the second mobility device MLT 2.

An embodiment of the present disclosure may include a pivot mechanism as first and second connection mechanisms. However, the present disclosure is not limited thereto. For example, the first and second mechanisms may be known mechanisms that implement a non-rotational connection with respect to the Z-axis.

The second left-driving motor LM may include a rotational axis connected to the second left-wheel LW to provide a driving force to the second left-wheel LW.

The second right-driving motor RM may include a rotational axis connected to the second right-wheel RW to provide a driving force to the second right-wheel RW.

The second left-wheel LW and the second right-wheel RW may be respectively connected to the second left-driving motor LM and the second right-driving motor RM, thereby enabling independent driving from each other.

The second left-driving motor LM and the second right-driving motor RM may drive in the forward direction and in the reverse direction, respectively. When driven in the forward direction, the second mobility device MLT 2 may travel in the forward direction, and when driven in the reverse direction, the second mobility device MLT 2 may travel in the rear direction.

For example, the second left-driving motor LM and the second right-driving motor RM each may be implemented in an in-wheel driving system where each driving motor is provided in wheels. However, the present disclosure is not limited thereto.

In another embodiment, the second mobility device MLT 2 may not operate independently on the left and right, but the driving force of a single common motor may be delivered into the second left-wheel LW and the second right-wheel RW. In an example, a vehicle gear may be included between the common second driving motor, the second left-wheel LW, and the second right-wheel RW. The driving force of the second driving motor may be divided by the vehicle gear and transmitted to the second left-wheel LW and the second right-wheel RW. A toque vectoring means may be added for torque distribution between the second left-wheel LW and the second right-wheel RW.

Referring to FIG. 2, the second controller Ctrl 2 may control the second left-driving motor LM and the second right-driving motor RM to achieve forward driving and reverse driving of the second mobility device MLT 2. The second controller Ctrl2, when the steering of the second mobility device MLT 2 is needed, may change the driving direction of the second mobility device MLT 2 by controlling respective toques or the rotation numbers of the second left-driving motor LM and the second right-driving motor RM. Through the independent control of driving of the second left-driving motor LM and the second right-driving motor RM, the steering of the second mobility device MLT2 may be ensured without a separate steering device.

Wired and wireless communication means may be included to deliver information between connectors in FIG. 1, the first mobility device MLT 1, and the second mobility device MLT 2.

According to an embodiment of the present disclosure, the first controller Ctrl 1 or the second controller Ctrl 2 may include a memory and a processor. The memory may store computer commanders (programs) for performing the functions of the controller, and the processor may perform the functions by loading and executing the commands from the memory.

The memory may include at least one of hard disk drive (HDD), solid-state drive (SDD), silicon disk drive (SDD), ROM, RAM, CD-ROM, magnetic tape, floppy disk, and optical data storage device.

The processor may include at least one of a computer, a microprocessor, a central processing unit (CPU), an ASIC, an electric circuit, and a logic circuit.

The first connector C1 and the second connector C2 of the first mobility device MLT1 may be connected to the third connector C3 and the fourth connector C4 of the second mobility device MLT2. As a signal transmission connector is connected, the first mobility device MLT 1 and the second mobility device MLT 2, i.e. the first controller Ctrl 1 and the second controller Ctrl2 may communicate with each other.

When the first mobility device MLT 1 and the second mobility device MLT 2 are mechanically and electrically connected, and the first mobility device MLT 1 starts the forward driving, the second controller Ctrl 2 may perform the straightforward driving of the second mobility device MLT 2 by controlling the second left-driving motor LM and the second right-driving motor RM according to the signal received from the first connector C1.

Some or all of the speed, gear position, steering angle, accelerator pedal sensor (APS) information, and/or brake pedal sensor (BPS) information of the first mobility device MLT 1 may be transmitted to the second mobility device MLT 2.

The second controller Ctrl 2 of the second mobility device MLT 2 may determine whether the first mobility device MLT1 operates in the forward direction or in the reverse direction by using part or all of the speed, the gear position, the APS information, and the BPS information of the first mobility device MLT 1. However, the present disclosure is not limited thereto. In an example, the second controller Ctrl 2 may directly receive information on whether the first mobility device MLT1 operates in the forward direction or in the reverse direction from the first controller Ctrl 1.

When the first mobility device MLT 1 operates in the forward direction, the second controller Ctrl 2 may drive the second left-driving motor LM and the second right-driving motor RM in the forward direction to allow the second mobility device MLT 2 to operate in the straightforward direction. When the first mobility device MLT 1 operates in the reverse direction, the second controller Ctrl 2 may drive the second left-driving motor LM and the second right-driving motor RM in the reverse direction to allow the rear-driving of the second mobility device MLT2.

The second controller Ctrl 2 may determine the steering status based on steering angle information on the first mobility device MLT 1 and may perform the steering of the second mobility device MLT 2 accordingly.

The second mobility device MLT 2 may not include a separate steering device such as a steering wheel, a steering rack, etc., but may perform the steering through torque control of the second left-driving motor LM and second right-driving motor RM.

The second controller Ctrl 2 may calculate a driving torque for driving and a steering torque for steering for each of the second left-driving motor LM and the second right-driving motor RM to use for control.

For example, for the steering of the second mobility device MLT 2, the steering torque value of the second left-driving motor LM and the second right-driving motor RM according to the steering angle of the first mobility device MLT 1 may be included in a look-up table or a calculation program.

While driving in a straightforward direction, the speed of the second mobility device MLT 2 may be controlled not to exceed the speed of the first mobility device MLT 1. The pivot connection between the first mobility device MLT 1 and the second mobility device MLT 2 may be within a predetermined pivot angle. For example, while driving in the straightforward direction, when the speed of the second mobility device MLT 2 is equal to or smaller than the speed of the first mobility device MLT 1, the pivot angle of the second mobility device MLT 2 with respect to the first mobility device MLT 1 from the pivot connection point may be 0 degree (an angle at which the first mobility device MLT 1 and the second mobility device MLT 2 are aligned).

While driving in the forward direction, the second mobility device MLT 2 may be controlled to follow the first mobility device MLT 1, thereby achieving continued and smooth driving of a plurality of mobility devices.

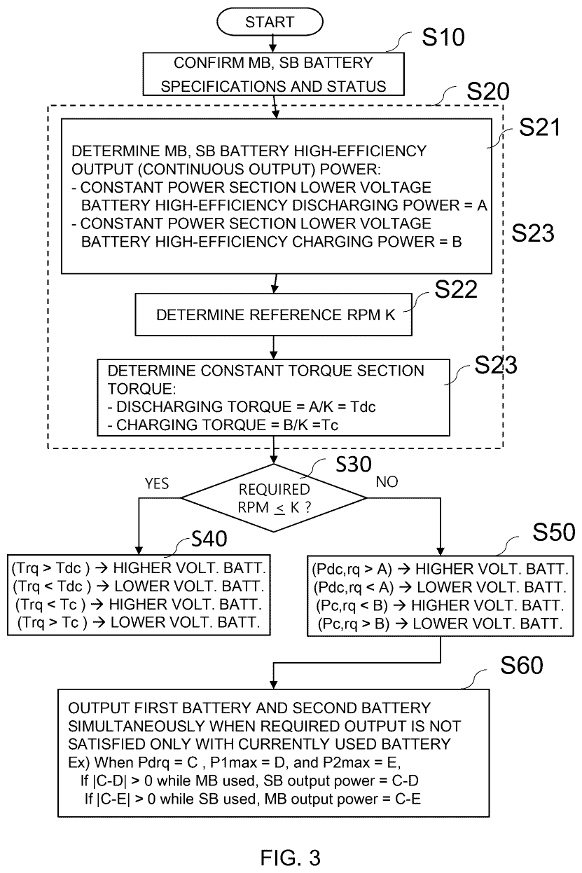

FIG. 3 is a flow chart illustrating a control process according to an embodiment of the present disclosure.

According to an embodiment, the control process of a battery may be performed under the control of the first controller Ctrl 1. However, the present disclosure is not limited thereto.

The first controller Ctrl 1 may include a memory and a processor. The memory may store computer programs for battery use control, and when necessary, various data for the control process. The processor may execute the programs stored in the memory, and the first controller Ctrl 1 may perform the battery use control according to the programs.

Referring to FIG. 3, at a step or operation S10, the first controller Ctrl 1 may identify the specifications and status of the first high-voltage battery MB and/or the second high-voltage battery SB.

The battery specifications may include at least one of a C-rate, a nominal voltage, an efficiency, a maximum current, a system voltage, and a continuous output, and the battery status may include at least one of a State of Health (SOH), a SOC, a voltage, and/or a temperature.

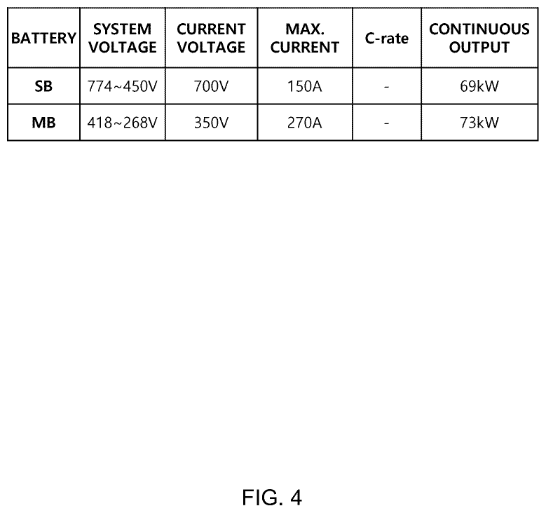

FIG. 4 is a view illustrating the specifications of the first high-voltage battery MB and the second high-voltage battery SB, according to an embodiment.

FIG. 4 illustrates that the first high-voltage battery MB is a lower voltage battery than the second high-voltage battery SB, but the present disclosure is not limited thereto.

The first controller Ctrl 1 may determine that the first high-voltage battery MB is a lower-voltage battery based on the specifications of the first high-voltage battery MB and the second high-voltage battery SB.

The first controller Ctrl 1, in a step or operation S20, may determine the high-efficiency output power, an Accelerator Pedal Sensor (APS) conversion value, and a reference revolutions per minute (RPM) of a lower voltage battery between the first high-voltage battery MB and the second high-voltage battery SB, i.e. the first high-voltage battery MB.

For example, the memory may store high-efficiency output data for each battery specification. The first controller Ctrl 1 may select the data that matches the specification of the first high-voltage battery MB and determine the high efficiency output power.

In a step or operation S21, high-efficiency discharging power A and charging power B in a constant power section MS 2 for the first high-voltage battery MB may be determined.

The first controller Ctrl 1 may determine an APS conversion value for the high-efficiency output power A and B. In an example, a torque may be determined by the APS conversion value, and a constant APS reference line may be a constant torque reference line of the torque accordingly.

For example, a required APS value determined by how hard a driver presses an acceleration pedal may be predetermined and may be converted into a required output of the first driving motor M by using an equation stored in the memory and the first controller Ctrl 1 may convert a high-efficiency output into an APS value by using the equation.

The first controller Ctrl 1 may determine a reference RPM (K) for the RPM reference line to be described below based on the torque-RPM map for the first driving motor M in a step or operation S22.

For example, the first controller Ctrl 1 may determine an RPM where a maximum torque Tq,max line intersects a maximum output Pwr,max line of the driving motor M in the torque-RPM map as the reference RPM (K).

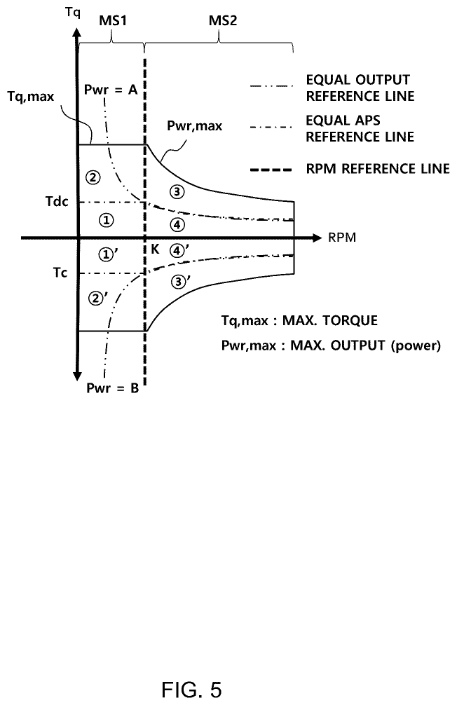

For example, the first controller Ctrl 1 may determine an RPM where a maximum torque line Tq=Tq,max intersects a maximum output line Pwr=Tq,max in the torque-RPM map in FIG. 5 as the reference RPM (K).

In a step or operation S23, the first controller Ctrl 1 may determine a discharging torque Tdc and a charging torque Tc for a constant torque section MS 1 based on the equation below.

Tdc=A/K

Tc=B/K [Equation 1]

The first controller Ctrl 1 may compare a required RPM based on the operation point of the driving motor M with the reference RPM (K) in a step or operation S30.

The first controller Ctrl 1 may proceed in a torque control mode to perform a step or operation S40 when the required RPM is equal to or smaller than the reference RPM (YES in the step or operation S30). On the other hand, when the required RPM is greater than the reference RPM (NO in the step or operation S30), the first controller Ctrl 1 may proceed in a power control mode to perform a step or operation S50.

In the step or operation S40, when the required torque is greater than the discharging torque Tdc, the first controller Ctrl 1 may determine to use (e.g., may select) the second high-voltage battery SB, which is a relatively higher voltage battery. On the other hand, when the required torque is smaller than the discharging torque Tdc, the controller Ctrl 1 may determine to use (e.g., may select) the first high-voltage battery MB, which is a relatively lower voltage battery.

When the required torque of the regenerative braking is smaller than the charging torque Tc, the first controller Ctrl 1 may determine to use (e.g., may select) the second high-voltage battery SB, which is a relatively higher voltage battery. On the other hand, when the required torque of the regenerative braking is greater than the charging torque Tc, the first controller Ctrl 1 may determine to use (e.g., may select) the first high-voltage battery MB, which is a relatively lower voltage battery.

In the step or operation S50, when a required power Pdc,rq is greater than the discharging power A, the first controller Ctrl 1 may determine to use (e.g., may select) the second high-voltage battery SB, which is a relatively higher voltage battery. On the other hand, when the required power Pdc,rq is smaller than the discharging power A, the first controller Ctrl 1 may determine to use (e.g., may select) the first high-voltage battery MB, which has relatively a low voltage.

When a required power Pc,rq of the regenerative braking is smaller than the charging power B, the first controller Ctrl 1 may determine to use (e.g., may select) the second high-voltage battery SB, which is a relatively higher voltage battery. On the other hand, when the required power Pc,rq of the regenerative braking is greater than the charging power B, the first controller Ctrl 1 may determine to use (e.g., may select) the first high-voltage battery MB, which is a relatively lower voltage battery.

After a high-voltage battery or a low-voltage battery is determined (e.g., selected) in the step or operation S40 or the step or operation S50, and when the determined (e.g., selected) battery fails to satisfy the required power, the first controller Ctrl 1 may determine to use (e.g., may select) other batteries in a step or operation S60.

For example, when a required power Pdrq of the driver is C, a maximum output power P1max of the first high-voltage battery MB is D, and a maximum output power P1max of the second high-voltage battery SB is E, after determination of use of the first high-voltage battery MB, when it is determined that the maximum output power P1max of the first high-voltage battery MB is smaller than the required power Pdrq of the driver, which is C, the second high-voltage battery SB may be used to cover a shortfall C-D. In this case, after the determination of use of the second high-voltage battery SB, when a maximum output power P2max of the second high-voltage battery SB is smaller than the required power Pdrq of the driver, which is C, the first high-voltage battery MB may be used to cover a shortfall C-E.

According to the high-efficiency output power A and B, the accelerator pedal sensor (APS) conversion value (e.g., Tdc and Tc), and the reference RPM (K) determined at step S20, a plurality of operation sections may be identified as shown in FIG. 5. The description thereof will be detailed below.

Referring to FIG. 5, a plurality of operation sections may be divided into a first operation section \textcircled{1}, a second operation section \textcircled{2}, a third operation section \textcircled{3}, and a fourth operation section \textcircled{4} by a constant power reference line, a constant APS reference line, and an RPM reference line.

Referring to FIG. 5, the first operation section \textcircled{1} may correspond to an area below the RPM reference line and the constant APS reference line, the second operation section \textcircled{2} may correspond to an area surrounded by the constant power reference line, the constant APS reference line, and the set maximum torque line, the third operation section \textcircled{3} may be determined as an area beyond the constant power reference line, and the fourth operation section \textcircled{4} may be determined as an area beyond the RPM reference line and below the constant power reference line.

Referring to FIG. 5, a torque area below zero (0) may be related to the regenerative braking situation of the first driving motor M, and may be divided into four (4) areas by the constant power reference line, the constant APS reference, and the RPM reference line.

Referring to FIG. 5, operation section division in the driving situation by the first driving motor M and the operation section division in the regenerative braking situation may be symmetrical with respect to an RPM axis.

According to the steps or operations S30-S50, in FIG. 5, when power is supplied to the driving motor M, i.e., in the battery discharging situation, the first high-voltage battery MB with a low voltage may be used in the first operation section \textcircled{1} and the fourth operation section \textcircled{4}, and the second high-voltage battery SB with a high voltage may be used in the second operation section \textcircled{2} and the third operation section \textcircled{3}.

According to the steps or operations S30-S50, in the regenerative braking situation, i.e., in the battery charging situation, the first high-voltage battery MB with a low voltage may be used in a first operation section \textcircled{1}′ and a fourth operation section \textcircled{4}′, and the second high-voltage battery SB with a high voltage may be used in a second operation section \textcircled{2}′ and a third operation section \textcircled{3}′.

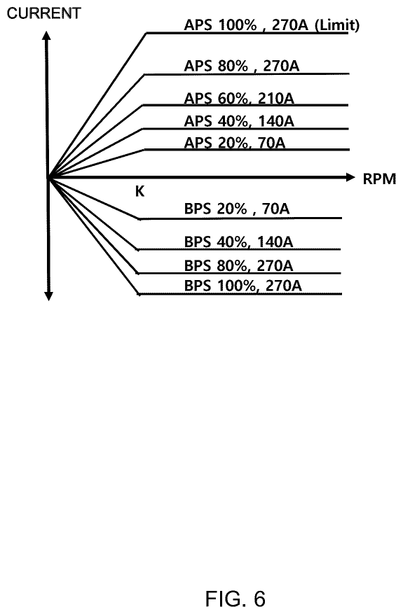

FIG. 6 illustrates the relationship between the current and the RPM of the driving motor M according to the required APS of the driver and a brake pedal sensor (BPS) signal when the first high-voltage battery MB is used. Although shown as a current in FIG. 6, since the profile of the current may be similar to the power profile under minor voltage fluctuations, the current may correspond to the required power of the driving motor M.

Referring to FIG. 6, according to how hard the driver presses the accelerator pedal, i.e. the APS signal, the RPM and the current may increase linearly until the RPM reaches K, and the current may be constantly maintained as the RPM increases. Referring to FIG. 6, it may be a constant torque section MS 1 until K, and a constant power section MS 2 after K.

Referring to FIG. 6, when the power generated from the driving motor M by the regenerative braking is charged with the first high-voltage battery MB, the generative braking may be performed with a constant torque until K, and the regenerative braking may be performed with a constant power after K.

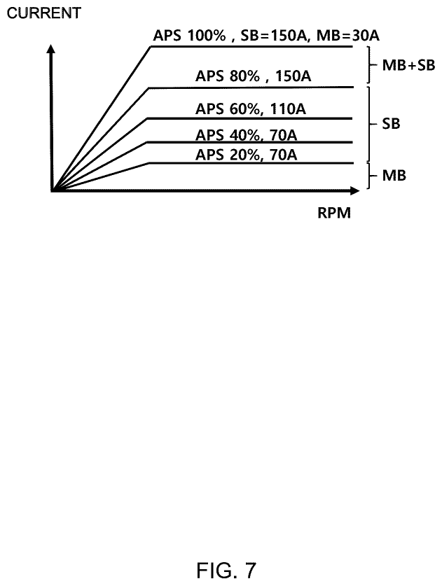

FIG. 7 illustrates the use of the first high-voltage battery MB and/or the second high-voltage battery SB according to the APS signal.

Referring to FIG. 7, when the APS signal is less than 20% (i.e. when the accelerator pedal is pressed about 20%), the operation point of the driving motor M may correspond to the first operation section \textcircled{1} or the fourth operation section \textcircled{4} in FIG. 5, and in this case, the first high-voltage battery MB may be used for supply power to the driving motor M.

In FIG. 7, when the APS signal is in the range of 20 to 80%, the operation point may correspond to the second operation section \textcircled{2} or the third operation section \textcircled{3}, and the second high-voltage battery SB may be used for the supply power.

Referring to FIG. 7, when the APS signal is in the range of 80% or more, the first high-voltage battery MB or the second high-voltage battery SB itself cannot satisfy the required power and in this case, maximum power may be output from the second high-voltage battery SB, and the remaining power shortfall may be output from the first high-voltage battery MB.

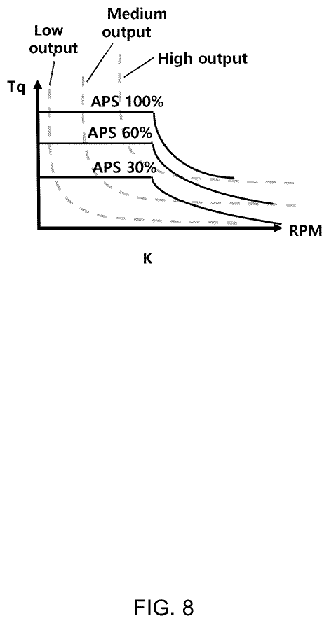

FIG. 8 illustrates that the driving motor M may drive with a constant torque until K and with a constant power after K for each APS signal.

The first controller Ctrl 1 may determine a driving mode, and when the determined driving mode is a high-torque mode (or a performance mode) between a low-power mode (or a normal mode) and a high-torque mode (or a performance mode), the control may be performed as shown in FIG. 3.

The low-power mode may include at least one of a Normal Mode, a Comfort Mode, an Eco Mode, and a Smart Mode, and the high-torque mode may include at least one of a Sports Mode and/or a Track Mode.

The normal mode may be, for example, a normal driving mode that balances the performance and the fuel efficiency of the vehicle.

The comfort mode may be, for example, a mode set to allow the driver to feel comfortable including acceleration, braking, and ride quality.

The eco mode may be, for example, a mode for optimizing the fuel efficiency of a vehicle. In the eco mode, acceleration may be slow and the transmission gear ratio may be high, so that energy consumption may be relatively reduced. The eco mode may also include a control to automatically turn off an air conditioning device to reduce electricity consumption.

The sports mode may be, for example, a mode for maximizing the performance of the vehicle. In the sports mode, the output of the first drive motor M may be increased and the transmission gear ratio may be lowered so that the vehicle may accelerate rapidly. In addition, the control may include an increase in steering assistance force and a stronger suspension system in the sports mode through which more agile driving may be achieved.

The track mode may be a mode designed for driving on a dedicated race track, for example, a track mode supported by Tesla vehicles. In the track mode, settings for stability control, traction control, regenerative braking, and cooling system may be changed to improve performance and handling.

The decision on the driving mode may be selected by the driver.

The first controller Ctrl 1 may identify whether one of a plurality of driving modes is selected by the driver.

Selecting the driving mode by the driver may be ensured by the input of the driver through the AVN screen, or the input means such as a button, a job stick, or a dial included in the first mobility device MLT 1.

When the driving mode is not selected by the driver, the first controller Ctrl 1 may determine the driving mode based on the operation point.

The first controller Ctrl 1 may determine one of a plurality of operation sections of FIG. 5 based on the operation point of the first driving motor M.

The first controller Ctrl 1 may determine the driving mode as the performance mode when the operation point of the first driving motor M changes from the second operation section \textcircled{2} to the third operation section \textcircled{3}.

For example, in the driving situation of the first driving motor M (i.e. when the torque is positive in the map of FIG. 5), when the required APS value of the driver is in a high-speed rapid acceleration situation or a long uphill driving situation, the operation point may be changed from the second operation section \textcircled{2} to the third operation section \textcircled{3} and the driving mode may be determined as the performance mode.

In the regenerative braking situation of the first driving motor M (i.e. when the torque is negative in the map of FIG. 5), when the required BPS value of the driver is a rapid downhill driving situation on a mountain road, the operation point may be changed from the second operation section \textcircled{2} to the third operation section \textcircled{3} and the driving mode may be determined as the performance mode.

The first controller Ctrl 1 may determine the driving mode as the performance mode when the operation point changes from the third operation section \textcircled{3} to the second operation section \textcircled{2}.

For example, in the driving situation of the first driving motor M, when the required APS value of the driver is a rapid uphill driving situation on a mountain road, the operation point may be changed from the third operation section \textcircled{3} to the second operation section \textcircled{2}, and the driving mode may be determined as the performance mode.

For example, in the regenerative braking situation of the first driving motor M, when the required BPS value of the driver is a high-speed rapid deceleration situation, the operation point may be changed from the third operation section \textcircled{3} to the second operation section \textcircled{2}, and the driving mode may be determined as the performance mode.

When the operation point changes from the second operation section \textcircled{2} to the first operation section \textcircled{1}, the driving mode may be determined as a low-power mode.

For example, when the required APS value indicates a rapid acceleration driving situation in the city or the required BPS value indicates a rapid deceleration driving situation in the city, the operation point may be changed from the second operation section \textcircled{2} to the first operation section \textcircled{1}, and the driving mode may be determined as a low-power mode.

The first controller Ctrl 1 may determine the driving mode as the performance mode when the driving mode is maintained for a set time or longer, for example, five (5) seconds or longer within the second operation section \textcircled{2}.

For example, when the required APS value indicates a mountain road uphill driving situation or the required BPS value indicates a mountain road downhill driving situation, the operation point may be maintained continuously in the second operation section \textcircled{2} and the driving mode may be determined as a low-power mode.

The first controller Ctrl 1 may determine the driving mode based on the location of Global Positioning System (GPS).

For example, the first controller Ctrl 1 may determine the driving mode as the performance mode based on the location of the first mobility device MLT 1 obtained from a GPS receiver in the case of mountain road driving situation.

Based on the location, in the case of driving on city roads, public roads, or highways, the driving mode may be determined as a low-power mode.

The first controller Ctrl 1 may determine a driving mode according to the transporting load of the first mobility device MLT1.

For example, when the first mobility device MLT1 is towing the second mobility device MLT2 or another vehicle, and the transporting load is greater than the setting load, the driving mode may be determined as the performance mode.

According to an embodiment, the low-power mode may be set as a default driving mode.

When the decision by the driver selection is not present, and the decision on the operation point, the transporting load, and GPS is not present, or although the decision is present, the driving mode may be set as the low-power mode in the beginning of the driving.

According to an embodiment, the first controller Ctrl 1 may determine that the second high-voltage battery SB is connected and added to the power system of the first mobility device MLT1.

According to an embodiment, the second high-voltage battery SB may be detachably connected, but the present disclosure is not limited thereto, and the control process according to an embodiment may be applied when the second high-voltage battery SB is fixedly placed in the first mobility device MLT 1.

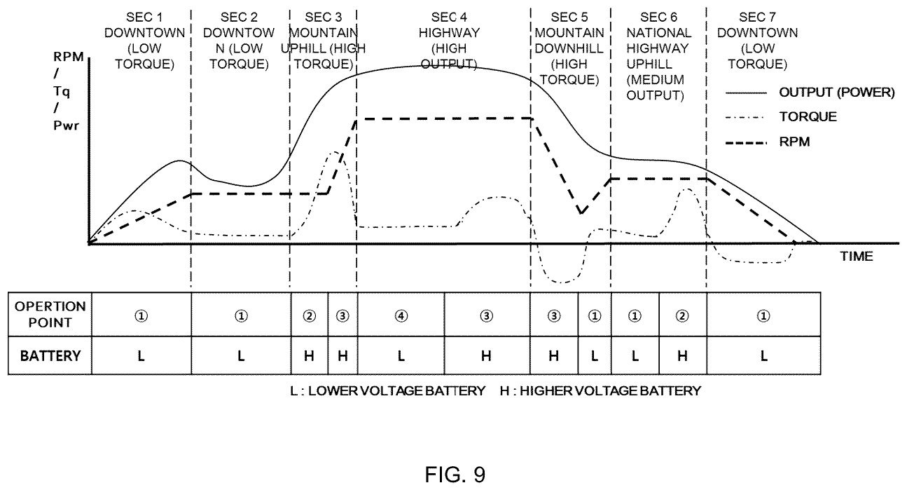

FIG. 9 is a view illustrating a driving simulation under the assumption according to an embodiment of the present disclosure.

The graph on the upper side in FIG. 9 illustrates an RPM, a torque, and a power of the first driving motor M according to driving times. The graph on the lower side of FIG. 9 illustrates an operation point and a battery used for each driving section. The low-voltage battery in FIG. 9 may be the first high-voltage battery MB, and the high-voltage battery may be the second high-voltage battery SB.

Referring to FIG. 9, the first mobility device MLT1 may drive from a first driving section SEC 1 to a seventh driving section SEC 7, the first driving section SEC 1 may be a low-torque driving situation on city roads, and the second driving section SEC 2 may be a low-power driving situation on city roads.

Referring to FIG. 9, the third driving section SEC 3 may be a high-torque driving situation as the uphill driving on mountain roads, and the fourth driving section SEC 4 may be a high-power driving situation as the highway driving.

The fourth driving section SEC 4 may be a high-torque regenerative braking situation as the downhill driving on mountain roads, and the sixth driving section SEC 6 may be a medium-sized power driving situation as the uphill driving on public roads.

The seventh driving section SEC 7 may be a low-torque driving situation on city roads.

In the driving situation as above, the operation points in the first driving section SEC 1 and the second driving section SEC 2 may correspond to the first operation section \textcircled{1}, the operation point in the third driving section SEC 3 may correspond to the second operation section \textcircled{2}in the first half, and the third operation section \textcircled{3} in the second half.

The operation point in the fourth driving section SEC 4 may correspond to the fourth operation section \textcircled{4} in the first half and to the third operation section \textcircled{3} in the second half.

The operation point in the fifth driving section SEC 5 may correspond to the third operation section \textcircled{3} in the first half and to the first operation section \textcircled{1} in the second half.

The operation point in the sixth driving section SEC 6 may correspond to the first operation section \textcircled{1} in the first half, and to the second operation section \textcircled{2}in the second half.

The operation point in the seventh driving section SEC 7 may be changed to the first operation section \textcircled{1}.

For the battery used in each section, the first high-voltage battery MB may be used in the first driving section SEC 1 and the second driving section SEC 2, and the second high-voltage battery SB may be used in the third driving section SEC 3.

The first high-voltage battery MB may be used in the first half of the fourth driving section SEC 4, and the second high-voltage battery SB may be used in the second half of the fourth driving section SEC 4.

The regenerative braking power generated in the fifth driving section SEC 5 may charge the second high-voltage battery SB in the first half of the fifth driving section SEC 5, and supply power to the first driving motor M by using the first high-voltage battery MB in the second half of the fifth driving section SEC 5.

The first high-voltage battery MB may be used in the first half in the sixth driving section SEC 6, and the second high-voltage battery SB may be used in the second half of the sixth driving section SEC 6.

The power generated in the seventh driving section SEC 7 may be used to charge the first high-voltage battery MB.

Hereinabove, although the present disclosure was described with reference to example embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

What is claimed is:

1. A method for controlling a battery of a vehicle including a plurality of wheels, a driving motor for supplying a driving force to the plurality of wheels, and a controller configured to control power supply to the driving motor or charging by the driving motor, the method comprising:
selecting, by the controller, a battery among a first battery and a second battery according to an operation point of the driving motor; and
controlling, by the controller, one or both of the power supply or the charging using the selected battery.

2. The method according to claim 1, wherein selecting the battery includes selecting the battery according to revolutions per minute (RPM), a torque, and a power of the driving motor.

3. The method according to claim 2, wherein selecting the battery according to the RPM, the torque, and the power of the driving motor includes determining a control mode among a torque control mode and a power control mode according to the RPM.

4. The method according to claim 3, wherein determining the control mode includes:
determining the torque control mode when the RPM is smaller than a reference RPM; and
determining the power control mode when the RPM is equal to or greater than the reference RPM.

5. The method according to claim 4, wherein selecting the battery when the torque control mode is determined includes:
when the torque is greater than a predetermined discharging torque, selecting a higher voltage battery among the first battery and the second battery;
when the torque is smaller than the predetermined discharging torque, selecting a lower voltage battery among the first battery and the second battery;
when the torque is smaller than a predetermined charging torque, selecting the higher voltage battery among the first battery and the second battery; and
when the torque is greater than the predetermined charging torque, selecting the lower voltage battery among the first battery and the second battery.

6. The method according to claim 4, wherein selecting the battery when the power control mode is determined includes:
when the power is greater than a predetermined discharging power, selecting a higher voltage battery among the first battery and the second battery,
when the power is smaller than the predetermined discharging power, selecting a lower voltage battery among the first battery and the second battery,
when the power is smaller than a predetermined charging power, selecting the higher voltage battery among the first battery and the second battery, and
when the power is greater than the predetermined charging power, selecting the lower voltage battery among the first battery and the second battery.

7. The method according to claim 3, wherein controlling the power supply or the charging using the selected battery includes additionally using another battery based on a determination that the selected battery fails to satisfy the power.

8. The method according to claim 2, wherein selecting the battery according to the RPM, the torque, and the power of the driving motor includes determining an operation section to which the operation point belongs among a plurality of operation sections, the plurality of operation sections being set based on a torque-RPM map of the driving motor.

9. The method according to claim 8, wherein the plurality of operation sections are set based on at least one of a constant power reference line, a constant APS reference line, and an RPM reference line.

10. The method according to claim 9, wherein the constant power reference line is set based on an efficiency of a lower voltage battery between the first battery and the second battery.

11. The method according to claim 9, wherein the plurality of operation sections include at least two or more of
a first operation section below the RPM reference line and the constant APS reference line,
a second operation section surrounded by the constant power reference line, the constant APS reference line, and a set maximum torque line,
a third operation section beyond the constant power reference line, and
a fourth operation section beyond the RPM reference line and below the constant power reference line.

12. The method according to claim 11, wherein selecting the battery includes at least one of:
in response the operation point being within the second operation section, selecting a higher voltage battery among the first battery and the second battery; and
in response to the operation point being within the fourth operation section, selecting a lower voltage battery among the first battery and the second battery.

13. The method according to claim 12, wherein selecting the battery includes at least one of:
in response to the operation point within the first operation section, selecting the lower voltage battery among the first battery and the second battery, and
in response to the operation point within the third operation section, selecting the higher voltage battery among the first battery and the second battery.

14. The method according to claim 1, further comprising determining a driving mode as a high-torque mode.

15. The method according to claim 14, wherein the high-torque mode includes at least one of a Sports Mode or a Track Mode.

16. The method according to claim 1, wherein selecting the battery incudes determining that the second battery is detachably connected to a power system including the first battery.

17. A controller comprising:
a memory storing instructions; and
one or more processors configured to execute the instructions,
wherein the instructions, when executed by the one or more processors, cause the one or more processors to
select a battery among a first battery and a second battery according to an operation point of a driving motor, and
control one or both of power supply to a driving motor in a vehicle or charging by the driving motor using the selected battery.

18. A vehicle comprising:
a plurality of wheels;
a driving motor configured to supply a driving force to the plurality of wheels; and
a controller including a memory storing instructions and one or more processors configured to execute the instructions to control power supply to the driving motor or charging by the driving motor,
wherein the instructions, when executed by the one or more processors, cause the controller to
select a battery among a first battery and a second battery according to an operation point of the driving motor, and
control one or both of the power supply or the charging using the selected battery.

19. The vehicle according to claim 18, wherein selecting the battery includes selecting the battery according to revolutions per minute (RPM), a torque, and a power of the driving motor.

20. The vehicle according to claim 19, wherein selecting the battery according to the RPM, the torque, and the power of the driving motor includes determining a control mode among a torque control mode and a power control mode according to the RPM.
